(19) United States
(12) Patent Application Publication
(10) Pub. No.: US 2019/0354910 A1
(43) Pub. Date: Nov. 21, 2019

(54) METHODS AND SYSTEMS FOR DYNAMICALLY SCHEDULING SPACES

(71) Applicant: MICROSOFT TECHNOLOGY LICENSING, LLC, Redmond, WA (US)

(72) Inventors: Daniel ESCAPA, Seattle, WA (US); Gregory Christopher John VANDENBROUCK, Bellevue, WA (US); Andres Carlo PETRALLI, Redmond, WA (US); Matthew Evan VOGEL, Seattle, WA (US)

(21) Appl. No.: 15/985,487

(22) Filed: May 21, 2018

(51) Int. Cl. G06Q 10/06; G06F 17/30

(52) U.S. Cl. CPC G06Q 10/06313; G06F 17/30702; G06Q 10/06312

(57) ABSTRACT

Dynamically scheduling spaces for one or more users may include accessing one or more sensors and/or services configured to monitor a plurality of physical spaces to obtain sensor data corresponding to each of the physical spaces of the plurality of physical spaces. User data associated with one or more users may also be accessed. Accessing the user data associated with the one or more users may include identifying one or more characteristics of the one or more users and/or a context of a meeting. Based on the sensor data and the user data, a physical space of the plurality of physical spaces may be correlated to the one or more users. A notification may also be sent to at least one of the one or more users that identifies the correlation between the physical space and the one or more users.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data.

As computing systems have become cheaper and smaller, they have begun to proliferate to almost all areas of life. For example, Internet of Things (IoT) devices are network-connected devices that are placed in many physical spaces to enable people to interact with and gather information about their environment. For example, offices or homes may include numerous IoT devices that can be used to control locks, to manage indoor climate and receive climate information, to manage lighting and receive lighting information, to open and close doors, to perform cleaning functions, to control audio and/or video equipment, to provide voice interaction, to provide security and monitoring capabilities, etc. As such, IoT devices can process and generate vast amounts of information. Such vast amounts of data may be used to more fully understand any given space or environment in which these IoT devices are located, any users within the given space or environment, and/or how the users interact with the given space or environment.

### BRIEF SUMMARY

At least some embodiments described herein relate to methods, systems, and computer program products for dynamically scheduling a space for one or more users based on sensor data, intelligent analysis of context, and so forth. Embodiments may include accessing one or more sensors configured to monitor a plurality of physical spaces to obtain sensor data corresponding to each of the physical spaces of the plurality of physical spaces. Embodiments may further include accessing user data associated with one or more users. Accessing the user data associated with the one or more users may include identifying one or more characteristics of the one or more users. Notably, in some embodiments, user data may be accessed or derived from sensor data. Embodiments may also include, based on the sensor data and the user data, correlating a physical space of the plurality of physical spaces to the one or more users, and sending a notification to at least one of the one or more users identifying the correlation between the physical space and the one or more users.

Accordingly, spaces (e.g., rooms within a building or set of buildings) may be intelligently and dynamically scheduled for use by one or more individuals. Scheduling may include an analysis of properties, factors, and data associated with available spaces, particular meetings, meeting types, users, and so forth. Such analyses may then allow determining a suitable space for any particular use and automatically scheduling the space for that use. Moreover, a hierarchical graph defining a topology of a physical space that may include devices and/or users, as well as a dynamic sensor data graph configured to process dynamic sensor data may allow for efficient and organized access to sensor data/properties associated with any given area/sub-area of a given physical space (e.g., IoT device/sensor data within the areas/sub-areas), as well as data associated with users. Such access to sensor data/properties may further lead to efficient analysis and scheduling of areas/sub-areas within the physical space.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore considered to be limiting of its scope, the invention will be described and explained with additional specificity and detail through the use of the accompanying drawings in which:

FIG. 1 illustrates an example computer architecture that facilitates operation of the principles described herein.

FIG. 2 illustrates an example environment for providing access to sensor data from devices within a physical space.

FIG. 3 illustrates an example hierarchical graph associated with a physical space.

FIG. 4 illustrates an example an example hierarchical graph associated with a physical space, as well as devices and users associated with areas or sub-areas of the physical space.

FIG. 5 illustrates a flowchart of a method for providing access to sensor data from devices within a physical space.

FIG. 6 illustrates an example environment for dynamically scheduling spaces for one or more users.

FIG. 7 illustrates a flowchart of a method for dynamically scheduling spaces for one or more users.

### DETAILED DESCRIPTION

In the realm of Internet of Things (IoT) devices, there are unique challenges associated with managing the devices, including challenges in managing a representation of the devices as they relate to their physical environment, challenges with handling the vast amounts of data generated by the devices, and challenges with managing user access to the devices and user access rights for associating devices with spaces. For instance, a large organization may own several campuses in different geographical locations. Each of these campuses could be made of a large number of buildings, each of which could have many floors. Each of these floors, in turn could have a large number of physical spaces (e.g., conference rooms, offices, common areas, laboratories, etc.). Each of these physical spaces could include a number of objects, such as desks, chairs, lab equipment, etc. Each of these physical spaces and/or objects in the physical spaces could be associated with a number of IoT devices, each of which could include a number of sensors or other data-generating hardware. Prior approaches have failed to efficiently represent these physical spaces and IoT devices, while providing efficient access to the data generated by the IoT devices. Such access may include user information/data in relation to spaces and/or devices, as well as intelligent insights or inferences associated with users based on data related to the spaces and/or devices. Additionally, prior approaches have failed to provide efficient mechanisms for managing user access as it relates to devices (e.g., user access rights for accessing sensor data and/or user access rights for managing the devices themselves), and/or for managing user access as it relates to physical spaces (e.g., for managing the layout of spaces including their sub-spaces, for managing adding/removing/managing devices in spaces, etc.). For instance, for a large organization, placing all of this data in a single hierarchical graph could result in a graph that is very large both in terms of depth and breadth—and which would require expensive graph traversal operations every time sensor data needs to be updated or accessed.

In view of this recognition, the inventors have invented a multi-database environment for storing such data. In particular, the multi-database environment can include one or more first data structures (e.g., one or more graphs) that store relatively static information in the form of a topology of the physical environment in which the IoT devices exist, including storing references to the devices themselves. The first data structure(s) are configured to facilitate queries that can quickly identify physical spaces, users, and/or IoT device(s) within physical spaces—regardless of the size of the topology; quick queries could mean a tradeoff that operations updating the first data structure(s) is comparatively expensive. The multi-database environment can also include one or more second data structures that store relatively dynamic information, such as sensor data generated by the IoT devices. The second data structure(s) are configured to efficiently store constantly changing data, and to provide quick access to data generated by an IoT device once that device has been identified using the first data structure(s). Users may be managed within the first data structure(s) (e.g., as user nodes associated with device nodes and/or with nodes relating to physical spaces) and/or within the second data structure(s).

At least some embodiments described herein relate to methods, systems, and computer program products for dynamically scheduling a space for one or more users. Embodiments may include accessing one or more sensors configured to monitor a plurality of physical spaces to obtain sensor data corresponding to each of the physical spaces of the plurality of physical spaces. Embodiments may further include accessing user data associated with one or more users. Accessing the user data associated with the one or more users may include identifying one or more characteristics of the one or more users. Embodiments may also include, based on the sensor data and the user data, correlating a physical space of the plurality of physical spaces to the one or more users, and sending a notification to at least one of the one or more users identifying the correlation between the physical space and the one or more users.

Accordingly, spaces (e.g., rooms within a building or set of buildings) may be intelligently and dynamically scheduled for use by one or more individuals. Scheduling may include an analysis of properties, factors, and data associated with available spaces, particular meetings, meeting types, users, and so forth. Such analyses may then allow determining a suitable space for any particular use and automatically scheduling the space for that use. Moreover, a hierarchical graph defining a topology of a physical space and a dynamic sensor data graph configured to process dynamic sensor data may allow for efficient and organized access to sensor data/properties associated with any given area/sub-area of a given physical space (e.g., IoT device/sensor data within the areas/sub-areas), as well as data associated with users. Such access to sensor data/properties may further lead to efficient analysis and scheduling of areas/sub-areas within the physical space.

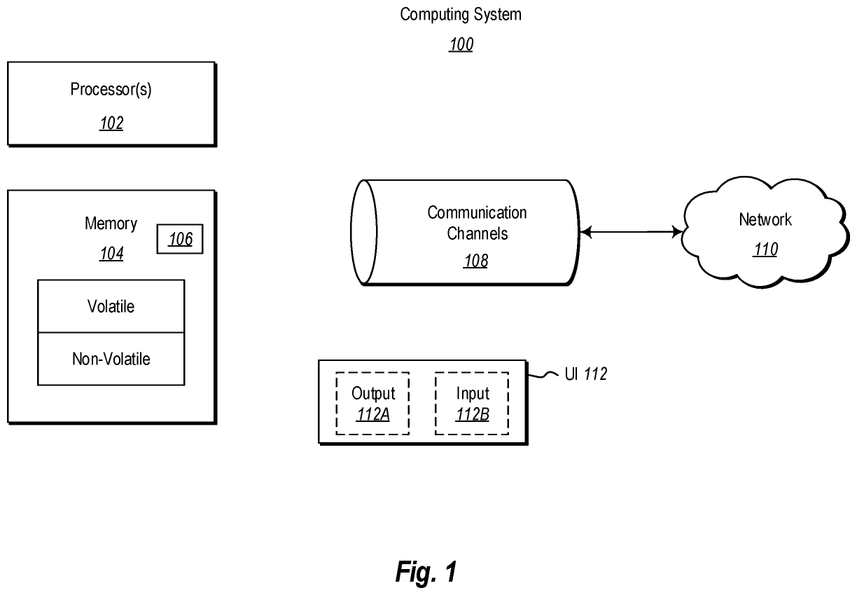

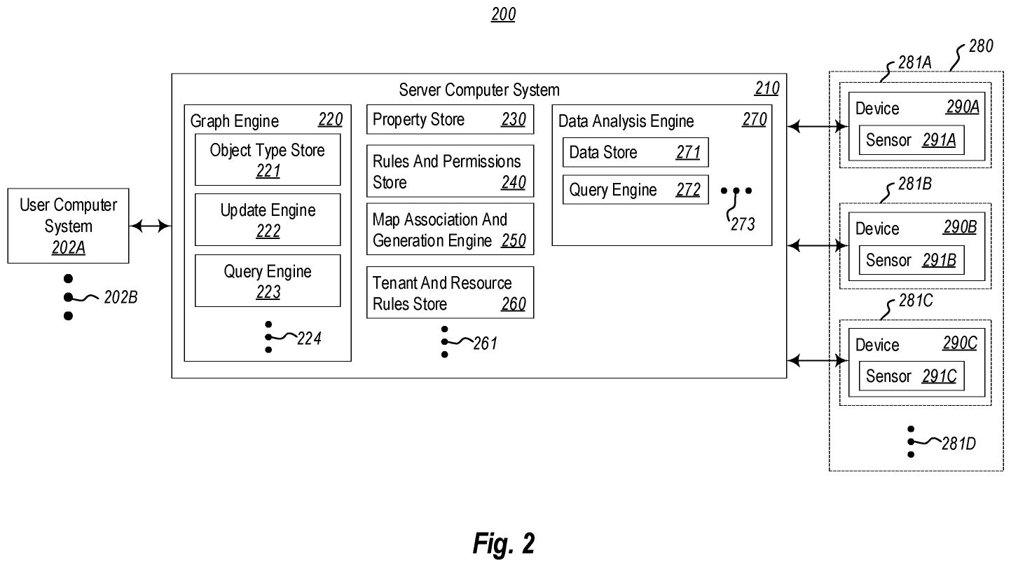

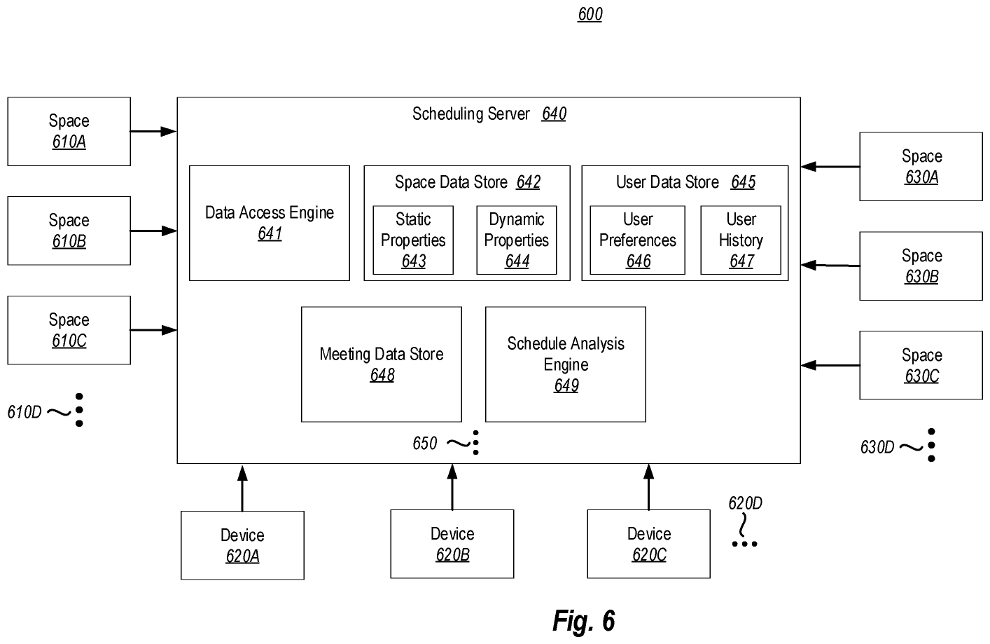

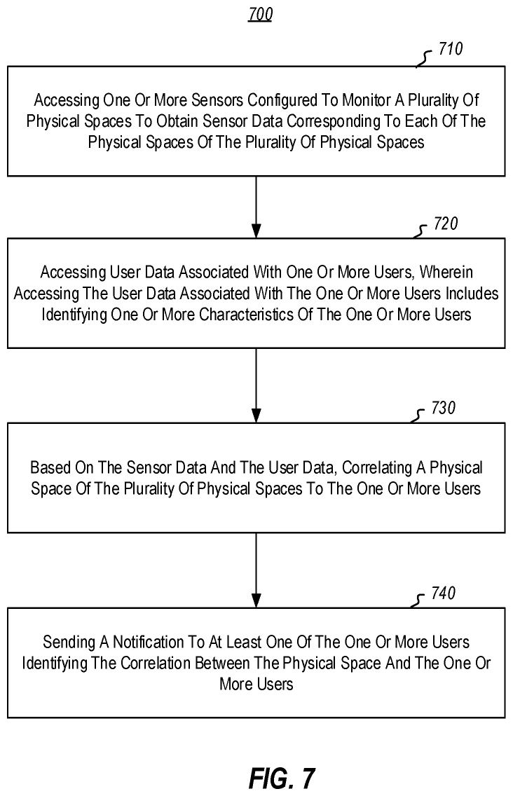

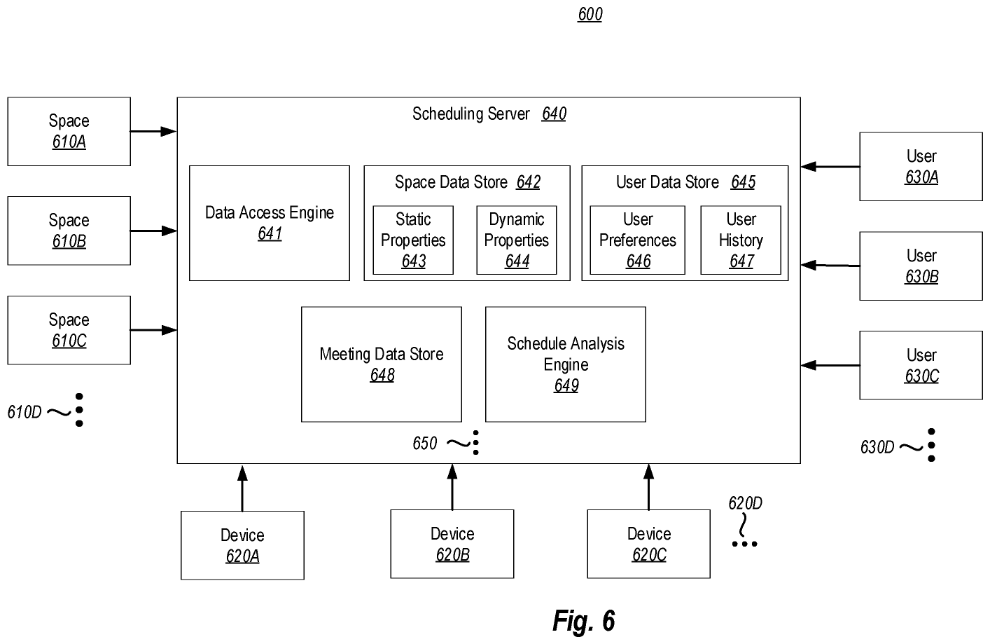

Some introductory discussion of a computing system will be described with respect to FIG. 1. Then, providing access to sensor data from devices within a physical space, consistent with the multi-database environment introduced above, will be described with respect to FIGS. 2 through 5, and executing business logic for an entity of a relational structure having a plurality of entities will be described with respect to FIGS. 6 and 7.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “control”, or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes NAND flash memory or other flash memory, RAM, DRAM, SRAM, ROM, EEPROM, CD-ROM or other optical disk storage, solid-state disk storage, magnetic disk storage or other storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation or interpretation) before direct execution by the processors, such as intermediate format instructions such as assembly language, or even source code.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment, which may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Reference is made frequently herein to Internet of Things (IoT) devices. As used herein, an IoT device can include any device that is connected to a network (whether that be a personal area network, local area network, wide area network, mesh network, and/or the Internet) and that interacts with a physical environment (whether that be to control or influence some aspect of a physical environment, and/or to receive sensor data from a physical environment). As such, references to IoT devices herein should be interpreted broadly to include vast categories of devices, regardless of how those devices may be named or marketed. From a computing perspective, IoT devices may range from fairly complex (e.g., such as being embodied on a general-purpose computer system), to fairly simple (e.g., such as being embodied within a special-purpose microcontroller environment).

FIG. 2 illustrates an example environment 200 for providing access to sensor data from devices within a physical space. As illustrated, the environment 200 includes a user computer system 202A. The user computer system 202A may be embodied, for example, by computer system 100, as described with respect to FIG. 1. The user computer system 202A may comprise any type of computer system that is configured to communicate with, and utilize the functionality of, a server computer system 210, which is described later. In an example, the user computer system 202A may comprise a desktop computer, a laptop computer, a tablet, a smartphone, and so forth. Notably, while the environment 200 includes a single user computer system 202A, the ellipses 202B represents that any number of user computer systems may communicate with, and utilize the functionality of, the server computer system 210.

The server computer system 210 is configured to receive, store, and provide access to sensor data from devices (such as IoT devices) located within physical spaces (e.g., a room within a building), as further described herein. Again, the server computer system 210 may be embodied, for example, by computer system 100, as described with respect to FIG. 1. The server computer system 210 may comprise any type of computer system, including any combination of hardware and/or software that is configured to provide access to sensor data from devices located within particular physical spaces.

As shown, the server computer system 210 may include various engines, functional blocks, and components, including (as examples) a graph engine 220, a property store 230, a rules and permissions store 240, a map association and generation engine 250, a tenant and resource rules store 260, and a data analysis engine 270, each of which may also include additional engines, functional blocks, and components (e.g., an object type store 221 within the graph engine 220). The various engines, components, and/or functional blocks of the server computer system 210 may be implemented on a single computer system, or may be implemented as a distributed computer system that includes elements resident in a cloud environment, and/or that implement aspects of cloud computing (i.e., at least one of the various illustrated engines may be implemented locally, while at least one other engine may be implemented remotely). In addition, the various engines, functional blocks, and/or components of the server computer system 210 may be implemented as software, hardware, or a combination of software and hardware.

Notably, the configuration of the server computer system 210 illustrated in FIG. 2 is shown only for exemplary purposes. As such, the server computer system 210 may include more or less than the engines, functional blocks, and/or components illustrated in FIG. 2. In particular, the ellipses 261 represent that any number of engines, functional blocks, and/or components may be utilized within the server computer system. Although not illustrated, the various engines of the server computer system 210 may access and/or utilize a processor and memory, such as the processor 102 and the memory 104 of FIG. 1, as needed, to perform their various functions.

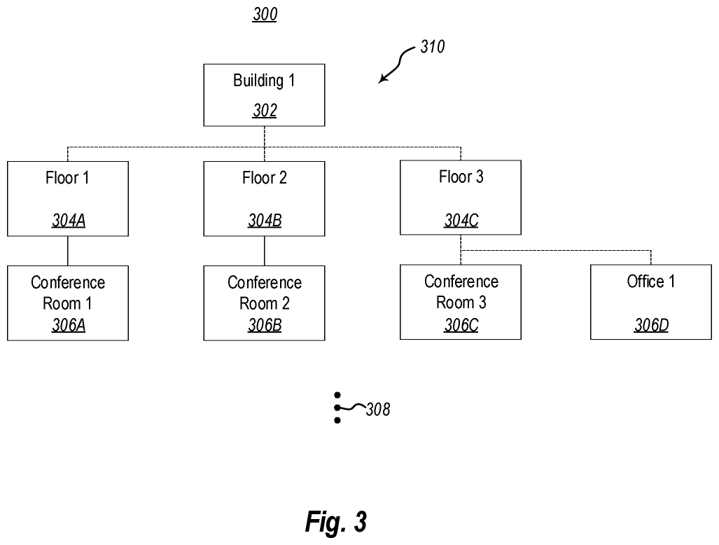

As briefly introduced, the server computer system 210 includes the graph engine 220, the property store 230, the rules and permissions store 240, the map association and generation engine 250, the tenant and resource rules store 260, and the data analysis engine 270. The graph engine 220 may be configured to generate, store, and/or manage one or more hierarchical graphs (e.g., hierarchical graph 310 of FIG. 3) that defines a topology of areas and sub-areas of a physical space. For instance, FIG. 3 illustrates a hierarchical graph 310 that includes a topology of nodes associated with a physical space comprising “building 1” (e.g., building node 302). The hierarchical graph 310 also represents areas and sub-areas of “building 1,” such as different floors (i.e., floor node 304A, floor node 304B, and floor node 304C, all of which are sub-nodes of building node 302), as well as different rooms (i.e., conference room node 306A, conference room node 306B, conference room node 306C, and office node 306D) associated with each floor. Although not shown, each of the room nodes 306A-306A could be associated with additional sub-nodes representing physical objects in the rooms, such as desks, chairs, tales, computer, lab equipment, etc.

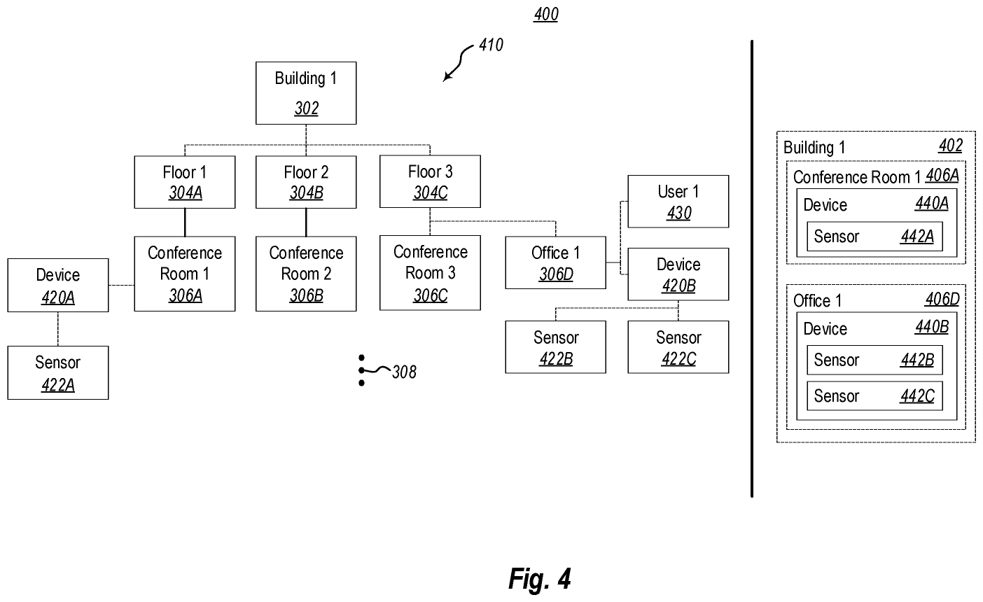

Any node in the hierarchical graph 310 could be associated with devices/sensors and/or users. For example, the various room nodes (i.e., the conference room node 306A and the office node 306D) may also be associated with devices and sensors, and the room nodes and/or the device/sensor nodes may be associated with user nodes. Similarly, FIG. 4 shows a related graph 410, that includes device nodes 420A and 420B and sensor nodes 422A-422C. While only seven nodes associated with areas/sub-areas are illustrated in FIG. 3, the ellipses 308 represents that any number of nodes that are associated with areas/sub-areas and devices/sensors may be utilized when practicing the principles described herein (whether those nodes be added or deleted in a horizontal direction (breadth) or a vertical direction (depth)). Furthermore, the topology of the graph may be continuously modified via adding or deleting nodes of the graph (in a horizontal direction or vertical direction). For instance, using the example of FIG. 3, a number of additional building nodes associated with different buildings than building 1 (corresponding to building node 302), each of which additional buildings may include additional nodes corresponding to floors, rooms, and so forth, may also be included within the graph 310.

In some embodiments, the hierarchical graph 310 may be stored within a relational database, though any type of database could be used. Additionally, regardless of the type of graph used, the full paths in the graph for each given node may be stored as metadata in the node to increase the performance and efficiency of querying the hierarchical graph 310. In this way, identification (e.g., via a query) of any ancestral node or child node (i.e., children nodes, grandchildren nodes, great-grandchildren nodes, and so on) of a given node may be performed in an order of one operation (i.e., an O(1) operation). For instance, a query that requests each node having a path that starts with “building1/floor3” (i.e., corresponding to the floor node 304C) may identify conference room 3 and office 1 (i.e., corresponding to conference room node 306C and office node 306D, respectively) as being children of the floor node 304C in an O(1) operation.

Notably, even if the conference room node 306C and the office node 306D were grandchildren, great-grandchildren, and so on, of the floor node 304C, a request for identification of each node having a path that starts with “building1/floor3” could result in identification of the conference room node 306C and the office node 306D (as well as any nodes between the floor node 304C and the conference room node 306C/the office node 306D) in an O(1) operation. Accordingly, paths associated with each node may be automatically computed and saved, which effectively tracks a primary identification for each node of the graph. While a cost is incurred upfront to generate and store each path (e.g., in connection with the addition and/or removal of one or more nodes to within the graph), the graph may be quickly and efficiently traversed to identify nodes and relationships between nodes within the graph than traditional traversing of graphs. By storing primarily static information in the graph, however, the need to generate/store these paths can be relatively infrequent.

Returning to FIG. 2, as illustrated, the graph engine 220 includes various components that may comprise any combination of appropriate hardware and/or software, including an object type store 221, an update engine 222, and a query engine 223. Notably, the ellipses 224 represents that any number of components may be included with the graph engine 220 (i.e., more or less than the components illustrated within the graph engine 220).

The object type store 221 comprises a data store of node object types that can be selected to create additional nodes within the graph 310. For instance, in addition to the node object types of buildings, floors, and rooms that are explicitly shown in FIG. 3, any number of object types associated with areas/sub-areas of physical spaces (as well as devices/sensors and users/individuals, as further described herein) may be used within the graph 310, including but not limited to organizations (e.g., businesses), geographic regions (e.g., continents, countries, states, cities, counties, and so forth), types of areas (e.g., buildings, farms, houses, apartments, conference rooms, offices, bathrooms, breakrooms, study areas, desks, chairs, and so forth), types of devices (e.g., thermostat, projector, paper towel dispenser, television, computer, and so forth), types of sensors (e.g., thermocouple, thermistor, humidity sensor, CO₂ sensor, Geiger counter), and so forth. Additionally, the object type store 221 may be extensible, such that additional object types may be created on demand.

The update engine 222 may be configured to update the hierarchical graph 310 with any changes made to the graph. For instance, the update engine 222 may update the graph with additional nodes, update the graph with less nodes (e.g., deleted nodes), update nodes with new or modified properties, update nodes with new or modified paths, and perform any other operations associated with modifying or updating the graph.

The query engine 223 may be configured to allow for performing queries to the hierarchical graph 310. In particular, the query engine 223 may be configured to receive queries, generate query plans, build responses to queries, and/or perform any other operations associated with receiving and responding to queries of the hierarchical graph 310.

As briefly introduced, the server computer system 210 further includes data analysis engine 270. The data analysis engine 270 may be configured to receive, gather, manage, and process data received from devices/sensors located within a physical space (associated with the hierarchical graph that defines the topology of the physical space). For instance, FIG. 2 illustrates various devices and sensors located within a physical space 280. In particular, the physical space 280 comprises various areas and sub-areas, including area/sub-area 281A, area/sub-area 281B, and area/sub-area 281C. Each of the sub-areas includes a single device having a single sensor (i.e., area/sub-area 281A includes device 290A having sensor 291A, area/sub-area 281B includes device 290B having sensor 291B, and area/sub-area 281C includes device 290C having sensor 291C). Notably, while each of the areas/sub-areas within the physical space 280 includes a single device having a single sensor, the ellipses 290 represents that there may be any number of areas/sub-areas within the physical space 280, each of the areas/sub-areas including any number of devices having any number of sensors (including zero devices/sensors). In addition, devices may also have one or more actuators that allow for sending a command to a device. For instance, such an actuator may allow for turning a light bulb on or off

Notably, the devices and sensors may include any type of devices/sensors, including but not limited to devices/sensors associated with detecting temperature, CO₂, light, pressure, toxic chemicals, humidity, and so forth. As such, the combination of the devices 290 (i.e., the device 290A through the device 290C) and the sensors 291 (i.e., the sensor 291A through the sensor 291C) may be configured to capture sensor data (e.g., changes in temperature) and send the captured data to the data analysis engine 270. The sensors may provide data to the data analysis engine 270 periodically and/or continuously. Thus, in some implementations, sensors the data analysis engine 270 may receive, gather, manage, and process real-time or near real-time data received from the sensors. The sensors may actively push data to the data analysis engine 270, or may only provide it upon request.

The data analysis engine 270 may then be configured to receive, gather, manage, and process data received from such devices/sensors. In particular, as illustrated, the data analysis engine 270 may include a data store 271 that is configured to organize, store, and allow access to received sensor data. The data store 271 may comprise any type of data store that is configured to manage dynamic, frequently changing data such as sensor data, and that provides quick and efficient performance. In an example, the data store 271 may comprise a key-value database. For instance, the data store 271 may comprise a distributed, in-memory key-value store. The data store 271 may store some data permanently, while only storing other data temporarily. For example, when receiving real-time or near real-time data, the data analysis engine 270 may process large quantities of data, making it infeasible and/or undesirable to store it permanently. Data associated with a particular device (e.g., sensor data) may also be linked with device nodes of the hierarchical graph (e.g., the hierarchical graph 410), such that upon identification of a device node within the hierarchical graph, sensor data associated with the device corresponding to the device node may also be accessed, as further described herein.

As shown, the data analysis engine 270 further includes a query engine 272. The query engine 272 may be configured to allow for performing queries to the data store 271. In particular, the query engine 272 may be configured to receive queries, generate query plans, build responses to queries, and/or perform any other operations associated with receiving and responding to queries of the data store 271.

FIG. 4 illustrates an environment 400 including hierarchical graph 410 comprising area/sub-area nodes, as well as device/sensor nodes that are each associated with one or more area/sub-area nodes. As shown, the conference room node 306A is associated with device node 420A (having a corresponding sensor node 422A) and the office node 306D is associated with the device node 420B (having two corresponding sensor nodes, the sensor node 422B and the sensor node 422C). Additionally, FIG. 4 includes a representation of an actual physical space 402 (associated with building 1) that corresponds to the building node 302.

As illustrated, the physical space 402 also comprises conference room 406A (associated with conference room 1 and corresponding to the conference room node 306A) that includes the actual physical device 440A having the sensor 442A, as well as office 406D (associated with office 1 and corresponding to the office node 306D) that includes the actual physical device 440B having both the sensor 442B and the sensor 442C. In a specific example, the device 440A may correspond to a thermostat that includes a thermocouple (i.e., the sensor 442A) for measuring temperature. Such temperature measurements may then be sent to the data analysis engine for managing, storing, and processing the received sensor data.

Additionally, as illustrated in FIG. 4, user nodes (e.g., user node 430) may be included within the hierarchical graph 410 as being associated with one or more area/sub-area nodes (though they could additionally, or alternatively, be associated with sensor/device nodes). In particular, FIG. 4 shows the user node 430 being associated with the office node 306D. In a specific example, the user 1 (i.e., corresponding to the user node 330) may comprise an individual that has been assigned to office 1 (i.e., corresponding to the office node 306D). Such an assignment may be an explicit assignment or may be inferred/determined based on real-time sensor data. In this example, user node 430 could be used to control a user's access to office node 306D, including, for example, the user's ability to modify office node 306D, to attached nodes to office node 306D, remove nodes from office node 306D, or modify nodes that are already attached to office node 306D, etc. In some embodiment, associating user node 430 with office node 306D applies the user node's permissions to all nodes hierarchically below office node 306D in hierarchical graph 410. Similar application of access rights could apply when associating a user node with a sensor/device node.

Notably, regardless of object/node type (e.g., area/sub-area nodes, device nodes, sensor nodes, user nodes), data and/or metadata associated with the node may be stored in the hierarchical graph (e.g., the hierarchical graph 310 or the hierarchical graph 410), the data store 271 of the data analysis engine 270, or any other appropriate location associated with the server computer system 210.

As briefly introduced, the server computer system 210 further includes property store 230, rules and permissions store 240, map association and generation engine 250, and tenant and resource store 260. The property store 230 may comprise a data store that includes properties associated with nodes of the hierarchical graph 310. For instance, properties associated with area/sub-area nodes may include types of devices/sensors (e.g., thermostat, ventilation sensors, and so forth) and/or equipment (e.g., whiteboards, audiovisual equipment, types of tables/desks, types of chairs, and so forth) included within the nodes. In another example, properties associated with device/sensor nodes may include types of generated data (e.g., temperature data), as well as actual generated data values (e.g., an actual detected temperature). In yet another example, properties associated with user nodes may include roles, permissions, preferences and/or historical data associated with users.

Notably, particular properties may automatically be associated with particular object types (i.e., node types), as well as children of such object types. In a more particular example, a property associated with occupancy of a chair within a room may propagate to the room itself (i.e., showing that the room is occupied) and further, as configured by a propagation policy. Furthermore, as discussed with respect to the object type store 231, the property store may also be extensible, such that properties may be created and associated with any given node, and potentially associated with ancestral or children nodes of the given node.

The rules and permissions store 240 may include various rules and permissions associated with particular roles assigned to users. For instance, based on a particular role (e.g., an administrator) assigned to a user, the user may have access to perform various operations, including adding/deleting nodes, modifying nodes, accessing/modifying functionality of various devices (e.g., locking doors), and so forth. The rules/permissions stored in the rules and permissions store 240 may be applied to various nodes in the hierarchical graph, whether those be area/sub-area nodes, sensor/device nodes, or user nodes. The rules/permissions stored in the rules and permissions store 240 may additionally, or alternatively, be applied data in the data store 271. In some embodiments, user nodes that are associated with nodes in the graph (e.g., areas or devices/sensors) grant corresponding users access to the associated node, and user rules/permissions associated with those user nodes are managed in the rules and permissions store 240.

The map association and generation engine 250 may be configured to perform numerous functions with respect to associating maps with the hierarchical graph (and devices providing data to the data store), and/or generating the hierarchical graph, itself. For instance, the map association and generation engine 250 may be able to generate the hierarchal graph 300 based on user input and/or based on a map. In another example, the map association and generation engine 250 may be able to link nodes of the hierarchical graph to locations or devices included within a map. In yet another example, the map association and generation engine 250 may further be able to generate a map based on information included within the hierarchical graph corresponding to nodes of the hierarchical graph.

The tenant and resource rules store 260 may include rules associated with how resources, permissions, properties, and so forth are to be handled for each given entity (e.g., tenant) that utilizes the hierarchical graph.

Notably, the ellipses 261 represent that the server computer system 210 may include any number of components (i.e., whether more or less) than the components illustrated within the server computer system in FIG. 2. For instance, while both the graph engine 220 and the data analysis engine 270 include corresponding query engines (i.e., the query engine 223 and the query engine 272, respectively), an overarching query engine may be included within the physical analytics computer system that allows for querying both the graph engine 220 and the data analysis engine 270. In this way, a user may be able to generate queries that can traverse the hierarchical graph (e.g., the hierarchical graph 410) to identify one or more devices associated with a particular area/sub-area of the hierarchical graph, as well as current (or previous) sensor data associated with the one or more devices via the data store 271 and the data analysis engine 270.

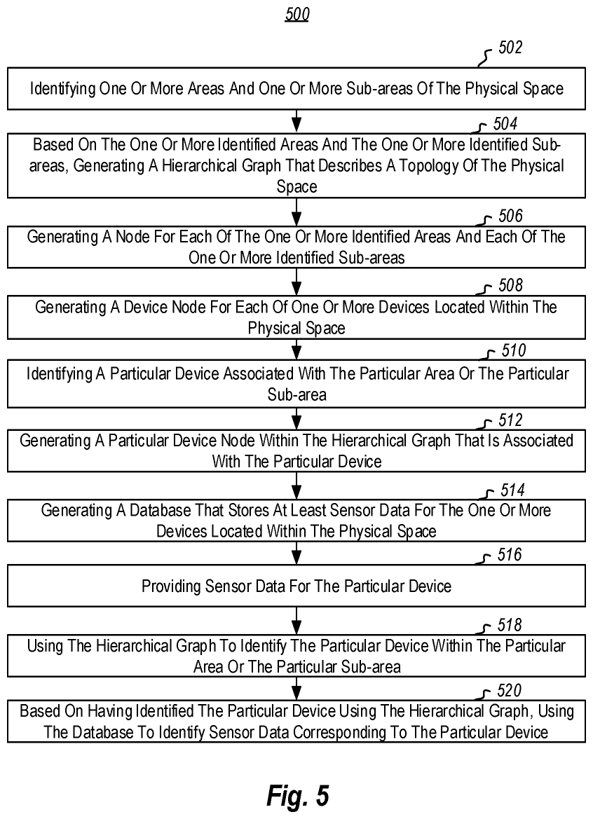

FIG. 5 illustrates a flowchart of a method 500 for providing access to sensor data from devices within a physical space. The method 500 is described with frequent reference to the environments of FIGS. 2-4. As shown, the method 500 includes identifying one or more areas and one or more sub-areas of the physical space (Act 502). For instance, the building 402, the conference room 406A, and/or the office 406D of FIG. 4 may be identified by the map association and generation engine 250. The method 500 further includes, based on the one or more identified areas and the one or more identified sub-areas, generating a hierarchical graph that describes a topology of the physical space (Act 504). For instance, based on the identification of the building 402 (and its corresponding areas/sub-areas), the hierarchical graph 410 may be generated by the map association and generation engine 250.

Generating the hierarchical graph further includes generating a node for each of the one or more identified areas and each of the one or more identified sub-areas (Act 506). For example, the hierarchical graph 410 includes various nodes based on an identification of areas/sub-areas associated with the building 402. Generating the hierarchical graph also includes generating a device node for each of one or more devices located within the physical space (Act 508). For instance, an identification of the device 440A and the device 440B may result in generating the device node 420A and the device node 420B, respectively.

Generating the device node for each of one or more devices located within the physical space further includes, for a particular one of the one or more areas or the one or more sub-areas, identifying a particular device associated with the particular area or the particular sub-area (Act 510). The particular device may include one or more sensors that generate data. For example, the device 440A may be identified, as well as the sensor 442A.

Generating the device node for each of one or more devices located within the physical space further includes, for a particular one of the one or more areas or the one or more sub-areas, generating a particular device node within the hierarchical graph that is associated with the particular device (Act 512). The particular device node may be a sub-node of a particular node that was generated for the particular area or the particular sub-area. For instance, the device node 420A may be generated in response to identifying the device 440A, and may further be associated with a particular area/sub-area node (i.e., the device node 420A being associated with the conference room node 306A). Additionally, any sensors associated with the device 440A may be identified, including the sensor 422A.

The method 500 further includes generating a database that stores at least sensor data for the one or more devices located within the physical space (Act 514). The database may be associated with, but separate from, the hierarchical graph. For example, the data store 271 may be generated for managing, storing, and accessing received sensor data. The method 500 may further include providing sensor data for the particular device (Act 516). For example, data from the sensor 442A of device 440A may be provided to the data store 271. In a more specific example, the sensor 442A may be configured to measure CO₂ levels, which measurements may be provided by the device 440A (or by another device capable of communicating with the device 440A) to the data store 271 (and ultimately, the data analysis engine 270).

Providing sensor data for the particular device may also include using the hierarchical graph to identify the particular device within the particular area or the particular sub-area (Act 518). For example, a query provided to the server computer system 210 (and perhaps directly to the graph engine 220) may request an identification of each device (and therefore each device node) associated with a particular area/sub-area (and therefore the particular area/sub-area node corresponding to the particular area/sub-area). Providing sensor data for the particular device may further include, based on having identified the particular device using the hierarchical graph, using the database to identify sensor data corresponding to the particular device (Act 520). For instance, upon identifying the device/device nodes (and the corresponding sensors/sensor nodes), sensor data associated with the devices/sensors may then be identified within the data store 271.

Accordingly, the principles described herein may allow for logically organizing devices (e.g., Internet of Things (IoT) devices) and/or users based on physical spaces (or areas/sub-areas of physical spaces), thus allowing for both intuitive organization, access, and control of a plurality of devices, as well as efficient use of such devices. For instance, each device associated with a particular area/sub-area (e.g., on a particular floor of a building or a particular room) may be easily shut off or placed in a reduced power state, as location-based groupings of devices are automatically created. In particular, relatively static physical space data (e.g., data regarding floors and rooms of a building) may be placed in a reliable graph (e.g., a relational database), while more dynamic sensor data may be managed in a more dynamic database (e.g., a distributed, in-memory key-value store).

The reliability of a hierarchical graph may be supplemented with quickness/efficiency by computing and storing paths associated with each node upfront when adding/removing/modifying nodes in the graph. Computing and storing the paths may then allow for performing queries with respect to ancestral nodes or child nodes of any given node in an O(1) operation. The hierarchical graph and the dynamic database may then be linked such that sensor data stored at the dynamic database may be quickly accessed when querying nodes associated with an area/sub-area within the hierarchical graph. Accordingly, storing the hierarchical graph and the dynamic database within an improved computer system (e.g., within memory and/or persistent storage) may improve the speed and efficiency of the computer system with respect to traversing the hierarchical graph in response to queries, building responses to queries (e.g., surfacing live sensor data associated with a particular area or sub-area of a physical space corresponding to the hierarchical graph), and so forth.

Notably, the hierarchical graph and dynamic sensor data graph may also be utilized for intelligent and dynamic scheduling of areas/sub-areas within a physical space that includes an associated hierarchical graph defining a topology of the physical space. As described herein, “scheduling” may refer to initially scheduling a room, as well as re-scheduling a room that has already been scheduled or re-scheduled one or more times. Generally, scheduling of rooms has previously been performed based only on availability of one or more rooms and availability of one or more individuals. However, using properties associated with available rooms, data associated with particular meetings, data associated with particular users, and so forth, dynamic scheduling of suitable rooms may be performed. In particular, as described throughout, the hierarchical graph and dynamic sensor data graph may allow for efficient and organized access to data (e.g., properties) associated with spaces (e.g., areas/sub-areas), devices/sensors (e.g., IoT device/sensor data within the areas/sub-areas), and/or users. Such access to sensor data/properties may further lead to efficient analysis and scheduling of areas/sub-areas within the physical space. In some embodiments, however, dynamic scheduling of spaces (e.g., areas/sub-areas of a physical space) may be performed without the use of the hierarchical graph and/or dynamic sensor data graph described herein.

Accordingly, FIG. 6 illustrates an example environment 600 for dynamically and intelligently scheduling the use of spaces (e.g., rooms) based on a combination of one or more attributes associated with users, spaces, meetings, and/or devices. As illustrated, the environment 600 includes spaces 610 (i.e., space 610A through space 610C), devices 620 (i.e., device 620A through device 620C), users 630 (i.e., user 630A through user 630C), and the scheduling server 640. While only three spaces 610, three devices 620, and three users 630 are illustrated in FIG. 6, the ellipses 610D, the ellipses 620D, and the ellipses 630D represent that there may be any number of spaces, devices, and users when practicing the principles described herein.

The spaces 610 may comprise any type of space/sub-space (e.g., areas/sub-areas of physical spaces, such as rooms, conference rooms, offices, study rooms, and so forth) associated with a larger space (e.g., one or more buildings, a campus, and so forth) that can be scheduled for various meetings (e.g., brainstorming sessions, client meetings, employee reviews, board meetings, and so forth) by the users 630. Accordingly, users may be any individual associated with the spaces 610 that can utilize and/or schedule use of the spaces. For instance, the users 630 may include employees, building administrators, executives, clients, and so forth that own, work within, or otherwise have access to one or more of the spaces 610. Notably, each space 610 may include one or more of the devices 620. For instance, such devices may include sensors associated with temperature, air quality (e.g., CO₂ levels), lighting, noise, humidity, occupancy, or even virtual sensors (e.g., a room scheduling data source). Accordingly, “sensors” can be partially or entirely virtual. A sensor, as used herein, does not have to be a physical device, but rather a “sensor” output could be a value provided by another cloud service or API. For example, a “sensor” could output the current weather forecast for a building's location from NOAA. In another example, virtual sensors may include historical data associated with preferences and/or characteristics of one or more users (e.g., rooms that have been historically booked by a particular user). In yet another example, virtual sensors may include current state data associated with a space (e.g., data indicating that a room has already been booked).

Data associated with such devices/sensors may then be provided to, and analyzed by, the scheduling server 640, as further described herein. Notably, each of the spaces 610, the devices 620, and the users 630 may correspond to nodes of a hierarchical graph (e.g., the hierarchical graph 310, the hierarchical graph 410, and so forth). For instance, the spaces 610 may correspond to area/sub-area nodes (e.g., conference room node 306A, office node 306D, and so forth) of the hierarchical graph 410, the devices 620 may correspond to device/sensor nodes (e.g., the device node 420A, the sensor node 422A, and so forth) of the hierarchical graph 410, and the users 630 may correspond to user nodes (e.g., the user node 430) of the hierarchical graph 410.

As briefly described, the environment 600 also includes the scheduling server 640. The scheduling server 640 may be embodied, for example, by computer system 100, as described with respect to FIG. 1. The scheduling server 640 may comprise any type of computer system, including any combination of hardware and/or software that is configured to that is configured to dynamically and intelligently schedule the use of spaces (e.g., rooms) based on a combination of one or more attributes and/or properties associated with users, spaces, meetings, and/or devices.

As illustrated, the scheduling server 640 may include various engines, functional blocks, and components, including (as examples) a data access engine 641, a space data store 642, a user data store 645, a meeting data store 648, and a schedule analysis engine 649, each of which may also include additional engines, functional blocks, and components. Notably, while not illustrated in FIG. 6, the scheduling server may also include a sensor data store. The various engines, components, and/or functional blocks of the scheduling server 640 may be implemented on a single computer system, or may be implemented as a distributed computer system that includes elements resident in a cloud environment, and/or that implement aspects of cloud computing (i.e., at least one of the various illustrated engines may be implemented locally, while at least one other engine may be implemented remotely). In addition, the various engines, functional blocks, and/or components of the scheduling server 640 may be implemented as software, hardware, or a combination of software and hardware.

Notably, the configuration of the scheduling server 640 illustrated in FIG. 6 is shown only for exemplary purposes. As such, the scheduling server 640 may include more or less than the engines, functional blocks, and/or components illustrated in FIG. 6. For instance, in some embodiments, the scheduling server may also include a device data store that is configured to store data associated with each device and/or sensor corresponding to the devices 620. In such embodiments, the device data store may correspond to the data analysis engine 270 and/or the data store 271, as further described with respect to FIG. 2. In particular, the ellipses 650 represent that any number of engines, functional blocks, and/or components may be utilized within the server computer system. Although not illustrated, the various engines of the scheduling server 640 may access and/or utilize a processor and memory, such as the processor 102 and the memory 104 of FIG. 1, as needed, to perform their various functions.

As briefly introduced, the server computer system 210 includes the data access engine 641, the space data store 642, the user data store 645, the meeting data store 648, and the schedule analysis engine 649. The data access engine 641 is configured to access data (e.g., receive, request, poll, and so forth) from a plurality of data sources including data sources associated with the spaces 610, the devices 620, and the users 630. In some embodiments, the data access engine may access data directly from devices located within spaces and users. In other embodiments, the data access engine may access data from nodes of a hierarchical graph (e.g., the hierarchical graph 310, the hierarchical graph 410, and so forth) and/or the data store 271. Notably, accessing the data from a hierarchical graph and/or a data store may allow for quick and efficient use of computer resources, as the data may already be largely organized and processed for use by the schedule analysis engine 649, as further described herein. Regardless of how such data is accessed, the data may then be provided to each of the space data store 642, the user data store 645, and the meeting data store 648, where the data is accessible by the schedule analysis engine 649 for further analysis.

The space data store 642 is configured to store data associated with each of the spaces 610. As illustrated, the space data store includes both static properties 643 and dynamic properties 644. Accordingly, each space 610 may include one or more static properties 643 and one or more dynamic properties 644. The static properties 643 may include properties that are more likely to change infrequently, including, but not limited to, devices located within a space (e.g., TV, thermostat, ventilation sensors, motion sensor, light sensor, audiovisual devices, and so forth), an ambience of a space, types of chairs within a space (e.g., stools, padded chairs having backrests, and so forth), types of desks within a space, a size of a space, a capacity of a space, whiteboards (size and/or number) within a space, or any other property of a space, and so forth.

The dynamic properties 644 may include properties that are more likely to change over time, including, but not limited to, temperature of a space, light within a space, noise associated with a space (e.g., inside or outside the space), ventilation of a space, humidity of a space, whether a service call has been placed to fix one or more items in a space (e.g., thermostat, projector, table), and so forth. Many dynamic properties may be determined at least partially using various devices (e.g., the devices 620) and/or sensors that are located within the spaces 610. Notably, the dynamic properties 644 may also include history information associated with dynamic properties during particular times of year and/or particular times of day. For instance, the dynamic properties may include information about a particular room that has historically had high temperatures in the morning during summer months.

The user data store 645 may be configured to store user data corresponding to a plurality of users (e.g., the users 630) that are associated with the spaces 610. For instance, the plurality of users associated with the spaces 610 may be able to schedule and/or utilize the spaces. As illustrated, the user data store may include both user preferences 646 and user history 647. The user preferences 646 may include a set of preferences associated with each user 630 that indicate preferences of the user with respect to spaces. For instance, user preferences may include preferences regarding room temperature (e.g., preference for a cooler room), devices/tools within a room (e.g., audiovisual equipment, whiteboards), accessibility preferences, and so forth. In some embodiments, user preferences may be explicitly defined by a given user (e.g., via a preferences user interface). Such user preferences may be explicitly defined and/or based on machine learning associated with users. In addition to user preferences, user availability (i.e., when a user may be available to meet) may also be stored and/or accessed with respect to the user data store 645.

The user history 647 may be configured to store historical data associated with a user in relation to the spaces 610. For instance, for a given user, the user history 647 may include data regarding types of meetings in which the given user has been involved, properties of spaces utilized by the given user, particular spaces utilized by the given user, spaces in which the given user has been the most productive or least productive, spaces in which the given user has been most comfortable or least comfortable, and so forth. In addition, such data may be aggregated such that spaces may be generally associated with various user characteristics, including but not limited to, productivity, comfortability, meeting types, and so forth.

In relation to productivity, numerous metrics may be collected and analyzed with respect to a particular user, including how often the particular user is in meetings, how many emails are sent by the particular user during particular meetings, how many emails the particular user has sent in general or within a given space, how long the particular user takes to read emails in general or in a given space, how often the particular user is responding to emails, how many hours the particular user is in an assigned office, how often the particular user is distracted during particular meetings or within particular spaces, and so forth.

In an example, a given user may be determined to be more productive when working in a space that is low levels of noise and a relatively cold temperature. Accordingly, preferences of a user may also be learned or inferred based on the user history 647. In another example, data may be gathered associated with a particular user that shows the particular user generally uses a relatively warm room with a whiteboard. The particular user may therefore have inferred preferences associated with warm spaces having a whiteboard.

Notably, while the space data store and the user data store are discussed as being separate data stores, data (e.g., properties, attributes, historical data) associated with the spaces, devices, and/or users may also be accessed directly from area/sub-area nodes (i.e., corresponding to spaces) of a hierarchical graph (e.g., the hierarchical graph 410), device/sensor nodes of the hierarchical graph, user nodes of the hierarchical graph, and/or the data store 271/data analysis engine 270. In this way, data associated with spaces, devices/sensors, and/or users may be quickly accessed, processed, and filtered without having to create stores for each entity that are separate from a hierarchical graph and/or the data store/data analysis engine.

The meeting data store 648 is configured to store data associated with particular types of meetings. For instance, types of meetings may include brainstorming meetings, client/customer meetings, planning sessions, board meetings, employee review meetings, and so forth. The meeting data store may further include properties of spaces associated with each of the types of meetings. In an example, brainstorming sessions may be associated with spaces having whiteboards, audiovisual equipment, stools or standing room only, and cooler temperatures. In addition to properties of spaces, meeting types may be associated with particular lengths of time.

In some embodiments, properties associated with given meeting types may be explicitly defined by users (e.g., administrators). Alternatively, or additionally, properties associated with given meeting types may be defined, and continually updated, based on historical data associated with the given meeting types. For instance, if employee reviews have continually been held in small conference rooms having particular audiovisual equipment, such properties may then be associated with an employee review meeting type.

The schedule analysis engine 649 may be configured to dynamically and intelligently schedule use of the spaces 610 using data associated with the spaces 610, the devices 620, the users 630, and/or meetings. In some embodiments, the schedule analysis engine 649 may be configured to use a combination of data from the space data store 642, the user data store 645, the meeting data store 648, and/or user-provided input (e.g., a request to schedule a meeting) to schedule use of the spaces 610. Alternatively, or additionally, the schedule analysis engine 649 may access data (e.g., properties, attributes, historical data) associated with the spaces, devices, and/or users directly from area/sub-area nodes (i.e., corresponding to spaces) of a hierarchical graph (e.g., the hierarchical graph 410), device/sensor nodes of the hierarchical graph, user nodes of the hierarchical graph, and/or the data store 271/data analysis engine 270.

Regardless of how such data is accessed, the schedule analysis engine 649 may automatically and dynamically schedule meetings in appropriate spaces. In an example, a request may be received that includes a type of meeting (e.g., board meeting), a length of the meeting, and/or the particular users being invited to the meeting. The schedule analysis engine may then analyze one or more of data associated with the meeting request (e.g., the meeting type, length of the meeting, the particular users invited, and so forth), data associated with the meeting type (e.g., via the meeting data store), data associated with one or more of the invited users (e.g., via the user data store), and/or data associated with one or more potentially available spaces for holding the requested meeting (e.g., via the space data store) to determine the most suitable space in which to hold the requested meeting.

In a specific example, assume the schedule analysis engine has received a request to schedule a planning session that is to be scheduled for at least two hours. The schedule analysis engine may then analyze various factors, including but not limited to, the meeting type, the length of the meeting, the number of users invited to the planning session, the particular users invited to the meeting, a proximity of invited users to available spaces, appropriate equipment based on meeting type, invited users, etc. (e.g., appropriate audiovisual equipment for invited remote users), and/or the available spaces for the planning session to determine the most suitable room. For instance, based on the length of the meeting, the schedule analysis engine may determine that a space having great ventilation and comfortable chairs is likely to be suitable to ensure CO₂ levels are minimal and users (i.e., meeting participants) remain comfortable throughout the duration of the meeting. Based on an analysis of the particular invited users, the schedule analysis engine may determine that the users generally prefer a cool, quiet environment. Similar analyses may be performed for any other given relevant factor. Upon such analyses, the schedule analysis engine may determine the most suitable space for the particular meeting context.

In some embodiments, the schedule analysis engine may automatically schedule spaces (e.g., rooms) for meeting based on an indication of a potential meeting rather than receiving an explicit request to schedule a space for a meeting. For instance, the schedule analysis engine may have access to messaging applications (e.g., instant messaging, email applications, and so forth) utilized by one or more users 630. Based on particular messages between users, the schedule analysis engine may then determine that a meeting is to be scheduled. For instance, the schedule analysis engine may identify a message from a first user to one or more second users that says, “We should get together to discuss business plans for the month of May.” Based on such a message, the schedule analysis engine may determine that a meeting is likely to take place between the first user and the one or more second users. In response to the determination, the schedule analysis engine may then determine one or more factors associated with the meeting, including a meeting type, users likely to be involved with the meeting (e.g., based on users included within the message, based on users involved in similar previous meetings, etc.), potential available spaces, and so forth. The schedule analysis may then determine a suitable room based on such factors and others described herein (e.g., properties of spaces, attributes of the meeting type, preferences and history of users, etc.). Upon such a determination, the schedule analysis engine may schedule the suitable room for a particular period of time (e.g., based at least partially upon identified availability of known or likely users that will attend) and notify each user that is likely to attend. In such cases, the schedule analysis engine may also make the scheduled space unavailable for use by others at least until one or more of the users likely to attend have either accepted or rejected the dynamically scheduled meeting.

The schedule analysis engine 649 may also consider other external, dynamic, or real-time factors associated with scheduling any given space. For instance, the schedule analysis engine may consider newly requested meetings even after other meetings have already been scheduled but not performed. For instance, assume a group of five individuals have scheduled a conference room that has a capacity of up to 20 people for a first meeting. Also assume that before the first meeting has taken place, the only other available space has a capacity of 10 people and a meeting request associated with a second meeting for 15 people has been received by the schedule analysis engine. The schedule analysis engine may then change the first meeting to the other available space having a capacity of 10, while scheduling the second meeting in the space having a capacity of 20.

In another example of external, dynamic, or real-time factors, the schedule analysis engine may identify that a user or group of users has scheduled a first space for a first portion of a given day and a second space for a second portion of the same, given day. If the first portion ends near the same time as the second portion begins, the schedule analysis engine may rearrange spaces, such that the user or group of users can meet in the first space or the second space for both the first and second portions. In yet another example of the external, dynamic, and/or real-time factors, the schedule analysis engine may also consider how to respond when a user or group of users is in a space past a scheduled time for the space, thus causing a second user or group of users to have to wait for scheduled use of the space. For instance, the schedule analysis engine may dynamically schedule a different space for the second user or group of users to utilize and notify the second user or group of users of the different space. The schedule analysis engine may then notify the first user and the one or more second users of scheduling of the room.

In addition to the external, dynamic, and or real-time factors described herein, the schedule analysis engine may also consider distances between rooms (e.g., in the case when one or more users have to travel from a first meeting to a second meeting), accessibility requirements of one or more users, fitness goals of one or more users, current working order of devices/equipment within a given space, current service requests associated with devices/equipment of a given room, or any other applicable factor. For instance, assume a first room that has great accessibility (e.g., wheelchair accessibility) has been initially scheduled by a first individual with no known mobility restrictions. Also assume that a second individual having known mobility restrictions also tries to schedule a room for a similar time frame. In such circumstances, the first room may be re-scheduled for the second individual, while a second, different room is scheduled for (or recommended to) the first individual. Accordingly, the schedule analysis engine may consider a number of factors including data associated with spaces, users, and/or meetings to automatically and dynamically schedule spaces for users or groups of users. The schedule analysis engine may then notify the users or groups of users when such scheduling has been performed.

In some embodiments, the schedule analysis engine may assign a score (e.g., from 1 to 100 with 100 being most suitable, from 0 to 1 with 1 being most suitable, and so forth) to spaces based on suitability of the spaces. For instance, scores may be generated for each space based on suitability for given meeting types, particular meetings, particular users or groups of users, and so forth. In a specific example, a particular space may have a high suitability score for brainstorming session meeting types and a low score for planning session meeting types. In another example, a particularly warm space may have a high suitability score for a first user that prefers warm spaces and a low suitability score for a second user that prefers cooler spaces. In some embodiments, the schedule analysis engine may use suitability scores to determine a space that comprises a global optimum based on an aggregate analysis of each user that may be attending a meeting.

In addition to scores, the schedule analysis engine may also create profiles for each space 610, user 630, meeting types, and/or particular meetings. Such profiles may be based on historical data, properties/characteristics of a given entity (e.g., spaces, users, etc.) explicit requests (e.g., a request for a whiteboard with respect to a particular meeting), historical data, and so forth. Notably, profiles may be created for each space and user with respect to a particular meeting or meeting type. For instance, a profile may be created for a space for any given meeting type or a particular meeting that has been held within the space, is going to be held within the space, and/or could be held within the space. Similarly, a profile may be created for a user for any given meeting type that has been held in association with the user, is going to be held in association with the user, and/or could be held in association with the user. These profiles may then be used for analysis in determining a suitable physical space for one or more users.

The schedule analysis engine may also allow for search or user interface filtering that allows a user to explicitly choose desired properties of a space to be scheduled (e.g., room size, number of chairs, whiteboards, audiovisual equipment, and so forth). Moreover, rather than automatically scheduling a suitable space, the schedule analysis engine may make recommendations to users based on an analysis of suitable spaces with respect to data associated with users, data associated with spaces, data associated with meetings, external data, dynamic data, and/or real-time data, as further described herein.

FIG. 7 illustrates a flowchart of a method 700 for dynamically scheduling spaces for one or more users. The method 700 is described with frequent reference to the environments of FIGS. 2-4 and 6. As shown, the method 700 includes accessing one or more sensors configured to monitor a plurality of physical spaces to obtain sensor data corresponding to each of the physical spaces of the plurality of physical spaces (Act 710). For example, the schedule analysis engine 649 may access sensor data from area/sub-area nodes of a hierarchical graph (e.g., the hierarchical graph 410), from device/sensor nodes of the hierarchical graph, directly from devices/sensors (e.g., the device 440A, the sensor 442A, the sensors 620), from the data analysis engine 270, from the data store 271, and/or the spaces data store 642.

The method 700 also includes accessing user data associated with one or more users, wherein accessing the user data associated with the one or more users includes identifying one or more characteristics of the one or more users (Act 720). For instance, the schedule analysis engine 649 may access user data associated with the one or more users 630 from the user data store 645 or directly from a hierarchical graph (e.g., the hierarchical graph 410). Characteristics of the one or more users may include historical data and/or preferences corresponding to the one or more users, for example.

The method 700 further includes, based on the sensor data and the user data, correlating a physical space of the plurality of physical spaces to the one or more users (Act 730). For instance, the schedule analysis engine may analyze data associated with a plurality of spaces (e.g., the spaces 610, the areas/sub-areas associated with area/sub-area nodes of a hierarchical graph) and one or more users (e.g., the users 630, users associated with user nodes of a hierarchical graph). In particular, such data may comprise characteristics, properties, historical data, preferences, and so forth related to the spaces and/or the users. Notably, such an analysis may also include an intended use of the space. For instance, such an intended use may comprise a type of meeting or a particular meeting that is to be held within a space of the plurality of spaces. Based on such an analysis, for example, the schedule analysis engine may then correlate a suitable space (e.g., a room) with the one or more users for use by the users during a given period time. The method 700 further includes sending a notification to at least one of the one or more users identifying the correlation between the physical space and the one or more users (Act 740). For instance, the schedule analysis engine may then notify the one or more users of the space correlated with (e.g., assigned to, scheduled for, reserved for, etc.) the one or more users.

Accordingly, spaces (e.g., rooms within a building or set of buildings) may be intelligently and dynamically scheduled for use by one or more individuals. Scheduling may include an analysis of properties, factors, and data associated with available spaces, particular meetings, meeting types, users, and so forth. Such analyses may then allow determining a suitable space for any particular use and automatically scheduling the space for that use. Moreover, a hierarchical graph defining a topology of a physical space and a dynamic sensor data graph configured to process dynamic sensor data may allow for efficient and organized access to data (e.g., properties, attributes, historical data, and so forth) associated with spaces (e.g., areas/sub-areas), devices/sensors (e.g., IoT device/sensor data within the areas/sub-areas), and/or users. Such access to data associated with spaces, devices/sensors, and/or users may further lead to efficient analysis and scheduling of areas/sub-areas within the physical space.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system comprising:
one or more processors; and
one or more computer-readable storage media having stored thereon computer-executable instructions that are executable by the one or more processors to cause the computer system to dynamically schedule a physical space for one or more users, the computer-executable instructions including instructions that are executable to cause the computer system to perform at least the following:
access one or more sensors configured to monitor a plurality of physical spaces to obtain sensor data corresponding to each of the physical spaces of the plurality of physical spaces;
access user data associated with one or more users, wherein accessing the user data associated with the one or more users includes identifying one or more characteristics of the one or more users;
based on the sensor data and the user data, correlate a physical space of the plurality of physical spaces to the one or more users; and
send a notification to at least one of the one or more users identifying the correlation between the physical space and the one or more users.

2. The computer system of claim 1, wherein the obtained sensor data comprises virtual sensor data.

3. The computer system of claim 1, wherein the obtained sensor data includes one or more static properties associated with the plurality of physical spaces.

4. The computer system of claim 3, wherein the one or more static properties include one or more devices associated with the plurality of spaces.

5. The computer system of claim 1, wherein the obtained sensor data includes one or more dynamic properties associated with the plurality of physical spaces that are expected change over time.

6. The computer system of claim 5, wherein the one or more dynamic properties include sensor data associated with the plurality of spaces.

7. The computer system of claim 1, wherein the user data includes historical data associated with the one or more users.

8. The computer system of claim 1, wherein the user data includes or one or more preferences associated with the one or more users.

9. The computer system of claim 1, wherein the computer-executable instructions further include instructions that are executable to cause the computer system to access data associated with an intended use of a physical space of the plurality of physical spaces.

10. A method, implemented at a computer system including one or more processors, for dynamically scheduling a physical space for one or more users, the method comprising:
accessing one or more sensors configured to monitor a plurality of physical spaces to obtain sensor data corresponding to each of the physical spaces of the plurality of physical spaces;
accessing user data associated with one or more users, wherein accessing the user data associated with the one or more users includes identifying one or more characteristics of the one or more users;
based on the sensor data and the user data, correlating a physical space of the plurality of physical spaces to the one or more users; and
sending a notification to at least one of the one or more users identifying the correlation between the physical space and the one or more users.

11. The method of claim 10, wherein the obtained sensor data comprises virtual sensor data.

12. The method of claim 10, wherein the obtained sensor data includes one or more static properties associated with the plurality of physical spaces.

13. The method of claim 12, wherein the one or more static properties include one or more devices associated with the plurality of spaces.

14. The method of claim 10, wherein the obtained sensor data includes one or more dynamic properties associated with the plurality of physical spaces that are expected change over time.

15. The method of claim 14, wherein the one or more dynamic properties include sensor data associated with the plurality of spaces.

16. The method of claim 10, wherein the user data includes historical data associated with the one or more users.

17. The method of claim 10, wherein the user data includes or one or more preferences associated with the one or more users.

18. The method of claim 10, further comprising:
accessing data associated with an intended use of a physical space of the plurality of physical spaces.

19. A computer program product comprising one or more computer readable media having stored thereon computer-executable instructions that are executable by one or more processors of a computer system to cause the computer system to dynamically schedule spaces for one or more users, the computer-executable instructions including instructions that are executable to cause the computer system to perform at least the following:
access one or more sensors configured to monitor a plurality of physical spaces to obtain sensor data corresponding to each of the physical spaces of the plurality of physical spaces;
access user data associated with one or more users, wherein accessing the user data associated with the one or more users includes identifying one or more characteristics of the one or more users;
based on the sensor data and the user data, correlate a physical space of the plurality of physical spaces to the one or more users; and
send a notification to at least one of the one or more users identifying the correlation between the physical space and the one or more users.

20. The computer program product in accordance with claim 19, wherein the one or more static properties include one or more devices associated with the plurality of spaces.
